(19) United States
(12) Patent Application Publication
(10) Pub. No.: US 2006/0104431 A1
(43) Pub. Date: May 18, 2006

(54) Method for providing feature interaction management and service blending

(76) Inventors: Richard Thomas Emery, Ocala, FL (US); Kristin Freya Kocan, Warrenville, IL (US); William D. Roome, Murray Hill, NJ (US); Ralph Victor Straubs, Naperville, IL (US); Byron J. Williams, Chicago, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/089,394

(22) Filed: Mar. 24, 2005

Related U.S. Application Data
(60) Provisional application No. 60/627,271, filed on Nov. 12, 2004.

(51) Int. Cl. H04M 3/42

(52) U.S. Cl. 379/211.04

(57) ABSTRACT

The present invention provides a method for providing a simultaneous ring and check presence prior to terminating service for a plurality of called phones in a simultaneous ring set. The simultaneous ring set includes a plurality wireline or wireless units. A service broker intercepts a call invitation message generated by a calling phone and intended for the simultaneous ring set. Upon determining that the simultaneous ring set has simultaneous ring service, the service broker determines the status of each of the plurality of called phones that are members of the simultaneous ring set. The service broker sends an invitation accept message for the responding unit of the simultaneous ring set to the calling phone, thereby completing the call between the calling phone and the responding unit of the simultaneous ring set.

### CROSS-REFERENCE TO RELATED APPLICATIONS

This application claims the benefit of U.S. Provisional Application No. 60/627,271, filed Nov. 12, 2004.

### FIELD OF THE INVENTION

The present invention relates generally to communication systems, and more particularly for communication systems that provide feature interaction management and service blending.

### BACKGROUND OF THE INVENTION

Controlling interactions between features and between services has historically been a very challenging area. Within telecommunication switching systems, potential interactions are examined and the desired interacting behavior is determined as part of feature design and development. This method of controlling interactions lacks flexibility and per-user customizability. As the “Intelligent Network” architecture was deployed in telecommunication networks, features were separated from the connection control, which is effected by telecommunication switching systems, to a services layer.

Feature interaction control was partially provided by the telecommunication switching system by managing triggers that were used to activate a feature in the services layer. This control often was not sufficient and a new sub-layer between the services layer and the call/connection control layer became useful for feature interaction management. The feature interaction management was controlled by provisioning, typically on a per-user basis. This method was more flexible, but still was typically limited to static sequencing of features or services.

The newer service architectures for communications, applicable to telecommunications and communications using other media types (e.g., data and video), retain the separation of services and call control; in fact, this separation is a major feature of these service architectures. Feature interaction management on a small-grained level could be incorporated within application servers supplying multiple features much as feature interaction management was provided in telecommunication switching systems.

Although additional customization is typically provided for some of the interactions by such application servers, the customizing control is limited to the features for which it is provided, and the options provided by the application server manufacturer. Additional feature interaction management can be provided by the call/connection control system, which is typically a SoftSwitch-like system.

This feature interaction management may be a simple trigger management mechanism, such as with the Intelligent Network, or it may be more sophisticated such as in the Serving Call Session Control Function of the IP Multimedia Subsystem architecture of 3GPP. In the latter case, “initial filter criteria” and “subsequent filter criteria” augment the trigger management significantly. However, the result still is restricted to largely static sequencing of application servers, with any dynamic component determined by the call control message stimulating feature activation. Additionally, each filtering rule is independent so that chaining of rules is not supported, rules are applied per-subscriber so that interactions between multiple subscribers are not dealt with, and each session is viewed as an independent entity so that multi-session awareness is not supported.

To allow more expansive feature interaction management, the IP Multimedia Subsystem standards define a function in the sub-layer of the services layer between call/connection control and the services layer proper for feature interaction management. This function is termed “Service Coordination and Interaction Manager” (SCIM). The precise operation and capabilities of the SCIM are not defined in the standards, nor are the means by which it would be configured.

In addition to feature interaction management, there is a desire to simultaneously leverage investment in service infrastructure and provide new service offerings by blending existing services in novel ways. The SCIM function or similar function at the sub-layer between the services layer proper and the call/connection control layer could be configured or augmented to provide such a capability. The combination of feature interaction management and service blending to provide new capabilities and enriched end-user experiences will be referred to as “service brokering.”

The shortcomings listed above that limit flexibility and dynamic ability, and several related limitations are a difficulties that restrict service brokering capabilities and utility. There are also several additional associated difficulties that need to be addressed for fully-effective service brokering.

A first associated difficulty is that interactions and service blendings for the same set of services are not typically identical. Different individuals and even different conditions for the same individual may require different interaction control or blending.

A second difficulty is that optimal interactions and service blendings may require information outside of events that invoke the services. These can include Presence, Location, policies, user information, end point information, previous events and other state information, and network information.

A third difficulty is that services may be short-lived. Replacement of a service providing a certain capability by another service offering to some extent the same or similar capability may be frequent, potentially affecting interaction and blending mechanisms.

A fourth difficulty is that interactions and service blendings that involve services other than communication services may be desired. Examples of such services include web services and special purpose application servers that do not utilize typical communication protocols.

A fifth difficulty is that future needs cannot be predicted. Conventional mechanisms to provision or otherwise configure feature interaction control and service blending, such as provisioning and graphical user interface configurators, are potentially limiting since the designers of the mechanisms would not be able to foresee all desired interactions and blendings.

### BRIEF SUMMARY OF THE INVENTION

This invention is directed to solving these and other disadvantages of the prior art. According to this invention, in a network for which services are provided in a separated layer, a system called a service broker is provided for feature interaction management and service blending that is maximally flexible from the standpoint of configuration and enables the use of information outside of events that invoke services. This system is able to effect feature interaction management and blending that involves services other than communication services. The system deals with the input/output behavior of application servers and is able to support application server change-out that substantially preserves input/output behavior with out modification of the service broker configuration. These capabilities are achieved by novel arrangement of functional modules and the introduction of a novel software structure, the steplet.

The mechanism for configuring the feature interaction management and service blending is an application programming interface (API) based on steplets. This mechanism provides unlimited flexibility in configuration since it can do anything the programming language (Java, in the example embodiment) can do, meaning any operation expressible in logic translatable to a general-purpose programming language, including interfaces to sources of information outside of events that invoke services. However, the novel distinction when compared to general purpose computers that support general purpose programming languages is that a steplet engine is introduced corresponding to the API; the steplet engine provides the common functions required for feature interaction management and service blending. As a result of the novel service broker engine, configuration of the feature interactions and service blendings, which uses the API, is tractable and in many cases actually easy, while at the same time unlimited flexibility remains. The functions of the service broker engine include message handling, structure for attribute binding to messages, session context and structure for attribute binding to session ID, structure for attribute binding to users, and correlation of incoming messages to in-progress activity.

In accordance with an exemplary embodiment of the present invention, Service Broker steplets, unlike servlets and SIP servlets, are designed to have the ability to cooperate; servlets operate with a single servlet per message and SIP servlets have one or more SIP servlets that are independent of each other per message. As part of the novel Service Broker design, all the steplets that handle a message share the same set of message and session attributes. Steplets can use those attributes to share data. Another aspect of the design is that a steplet can determine if a previous steplet has already forwarded a given message to an Application Server. Service Broker steplets can cooperate or can be independent; the programmer may use either approach.

A second aspect of an exemplary embodiment of the present invention is that in the Service Broker, the list of steplets for a message is dynamic, in that any steplet can add steplets to the list at any time. Preferably the first steplet for a message will determine the user for that message, will retrieve that user's profile information from a separate user database, and will use that to determine the next steplet or steplets to handle the message. This technique is very flexible, and given a high-capacity user database can easily handle millions of users.

A third aspect of an exemplary embodiment of the present invention is that in the Service Broker, when referring to another steplet, e.g., when adding a steplet to a message's steplet list, a steplet simply uses the full class name of that steplet. If a steplet needs additional configuration data or parameters, it can obtain that data from a Service Provider's user database or other databases.

A fourth aspect of an exemplary embodiment of the present invention is that the Service Broker engine provides a wait capability so that Service Broker steplets can wait for another message to arrive, thus releasing many of the resources needed to handle the steplet.

### BRIEF DESCRIPTION OF THE SEVERAL VIEWS OF THE DRAWINGS

FIG. 1 depicts a service broker in accordance with an exemplary embodiment of the present invention.

FIG. 2 depicts a logical representation of a Service Broker scenario in accordance with an exemplary embodiment of the present invention.

FIG. 3 depicts a call flow in accordance with an exemplary embodiment of the present invention.

FIG. 4 depicts a communication system in accordance with an exemplary embodiment of the present invention.

### DETAILED DESCRIPTION OF THE INVENTION

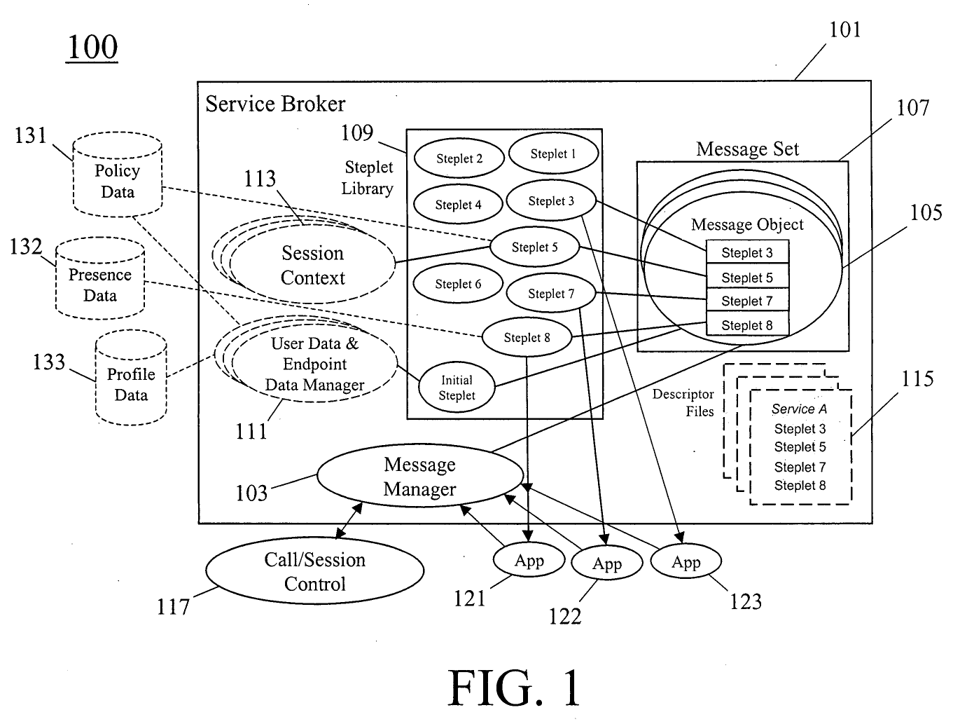

FIG. 1 depicts a service broker 101 in accordance with an exemplary embodiment of the present invention. The essential functional modules of the service broker, comprising the steplet engine, are depicted in FIG. 1. Message Manager 103 is module that stimulates action within the service broker as a result of an incoming message. Message Manager 103 includes the message protocol stack, such as a SIP stack, and a dispatcher for the novel software elements called steplets that determine the feature interaction or service blending. Message Manager 103 creates a unique Message Object for each request message received and appends it to the Message List.

A Message Object 105 is created for each message received and all other information bound to that message, including the list of steplets for execution and any desired attributes. Message Set 107 includes the list of all current Message Objects.

Steplet and Class Library 109 includes the steplets and classes that programmers extend, implement, or use directly. Session Context 113 is a structure for binding attribute data to session ID.

User Data and Endpoint Data Manager 111 is a structure for obtaining user data and endpoint data, caching the data, and binding attribute data to user ID. The data may be obtained from a Profile database 133.

Service Descriptor files 115 comprise an optional mechanism that associates a steplet ID or a list of steplet IDs with a defined feature interaction or service blending.

The steplet engine supports the operation of steplets, including their appropriate initialization, etc. In the example embodiment, steplet is a user-written class derived from a steplet base class. Steplets can perform many functions, including forwarding a particular request to an application server, sending a response, such as busy or redirect, for a particular request, sending a particular response to the next hop, sending an original request to another server instead of forwarding the request upstream, contacting special non-SIP servers, such as a Presence Server 132, a Location Server, a Policy Server 131, a Web Server, a database, a media resource server, or any other server, via any form of RMI/RPC protocol. Steplets are designed to support dynamic sequencing: they can name their successor steplet and they can easily share attribute data by means of the attribute binding structures in the steplet engine.

Further, steplets can wait for SIP messages without tying up thread resources by novel arrangement of capabilities within the steplet engine, specify the next steplet for a message, set or get attribute data, and implement service interaction control or service blending logic ranging from simple sequencing to the embodiment of complex algorithms or interfaces. From experience with the example embodiment, it is found that steplets can be quite compact, even for relatively complex operation.

In the example embodiment, Service Broker 101 is SIP-based and provides the Service Capability Interaction Manager (SCIM) functionality in IP Multimedia Subsystem and other Next Generation service architectures. Service Broker 101 would be used not only to manage service interaction, but also to provide enhanced end user experience by blending applications with each other and with Presence, Location, and Policy functions, and by incorporating multi-session awareness.

With the Service Broker, a minimal set of applications can be configured in a multiplicity of ways as its elements are brought into play, mixing and matching them with each other. In the example embodiment, the service broker API for supporting the degree of flexibility needed for Service Broker 101 to support unique service combinations is Java-based. The various functional sub-components in the steplet engine that are needed to enable these Service Broker capabilities are also Java-based.

Using the service broker API, Service Providers or their agents can incorporate service/application interaction and blending rules in Java programs that can be dynamically loaded into the Service Broker. The API enables maximum expressive freedom without restricting the creative talents of programmers needed to provide uniqueness and flexibility in interaction management, blending, and multi-session awareness. Providing an API based on standard Java gives the benefit of the excellent selection of off-the-shelf and open source Java IDEs, test environments, and other tools. The Java development shop used for providing the Service Broker programs can continue to use the tools (e.g., for editing and compiling) they find most productive; they do not need to learn and convert to a specialized set of tools (although a new library will need to be learned).

The goal of the API design is to facilitate rapid implementation of desired logic and usability by available Java programmers with no additional training (excepting familiarity with the API).

In the example embodiment, a description of the operation of Service Broker 101 follows. Upon receipt of any SIP message, Service Broker 101 first involves Message Manager 103, which creates a Message object for the message and initializes the Message object's steplet list to contain the Default Steplet. Message Manager 103 marks the Message object as “Ready,” which will eventually result in Message Manager 103 executing the Default Steplet on that message. The Default Steplet would typically be a steplet provided by the programmer using the API. The Default Steplet identifier is a configuration option. The function of the Default Steplet is to identify the steplets that are appropriate for the message and associated user and add the list of steplets to the Message object. In the example embodiment, this is done by pulling up user data by the User Data and Endpoint Data Manager 111.

Service Broker 101 executes the steplets on the list sequentially until no steplets remain. As noted, however, any steplet in the sequence can change the sequence. Steplets can mark a message as waiting, meaning that the steplet will continue to run on that message until it returns, but Message Manager 103 will not invoke the next steplet until the message is marked as ready. If a steplet sends out a SIP message, it may mark the Message object as “Waiting.” Typically, when a steplet sends a SIP message to an application server and waits for a response, the steplet forwards a copy of the message and marks the original message as waiting. Then the steplet returns. When the response message arrives at the service broker, a steplet invoked for the response message marks the original message as ready. This suspends work on the Message object after the steplet completes until a response message sets off a steplet that wakes up the Message object by marking it as Ready.

Service Broker 101 orchestrates a set of transactions that begins with an initial request. The initial request is the request message that sets in motion the whole sequence of events that achieves a particular service interaction control or service blending. Upon receipt of an initial request, Service Broker 101 operates in the following manner.

Message Manager 103 creates a Message Object 105 and dispatches the message as described above. In the example embodiment, steplets access Application Servers either via SIP or via some form of RPC protocol. If SIP is used, each message received will have its own Message object and unique message ID created by Message Manager 103. Service Broker 101 links these messages to the other messages involved in the activity set off by the initial request. The steplets may modify copies of the messages in the corresponding Message objects as needed for sending on.

Steplets access the User Data and Endpoint Data Manager 111 and the Session Context 113 as needed and correspondingly modify copies of the messages in the Message objects as needed, and may also add steplets to the Message objects as needed.

After the Final Steplet executes, Message Manager 103 either disposes of the message by sending it to call control 117 or disposes of the message by discarding it, as determined by one of the Steplets.

User Data and Endpoint Data Manager 111 is a per-(active) user component that caches user data, endpoint status, and characteristics associated with the user. User Data and Endpoint Data Manager 111 caches data identified by a “user” key.

Session Context 113 is a component where information obtained by steplets that needs to be persistent is stored. As used herein, the term “persistent information” refers to information that is retained over the life of the message, over the life of the associated dialog, or over an extended life. Session Context 113 caches data identified by a “session” key.

Descriptor files 115 may be used with an exemplary embodiment of the present invention, and each would include a list of steplets associated with a specific interaction control or blended service; the list of steplets is read by Message Manager 203 and written in the associated Message Object. In accordance with an exemplary embodiment of the present invention, a pre-coded table determines steplets associated with each user, although the means of identifying the steplet sequence can be altered by modifying the Default Steplet, for example to use descriptor files 115. Descriptor files 115 are read by steplets and constructed to match the form expected by the steplet.

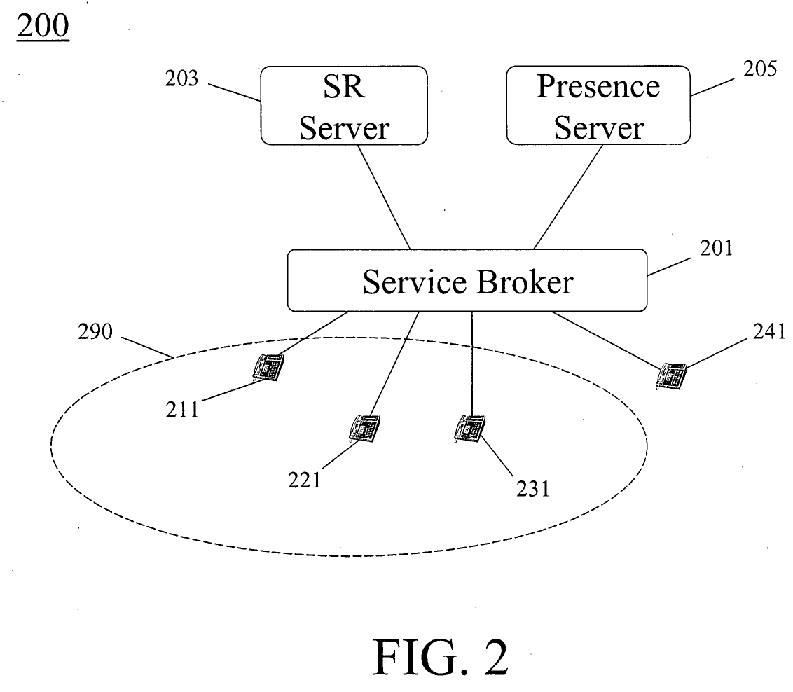

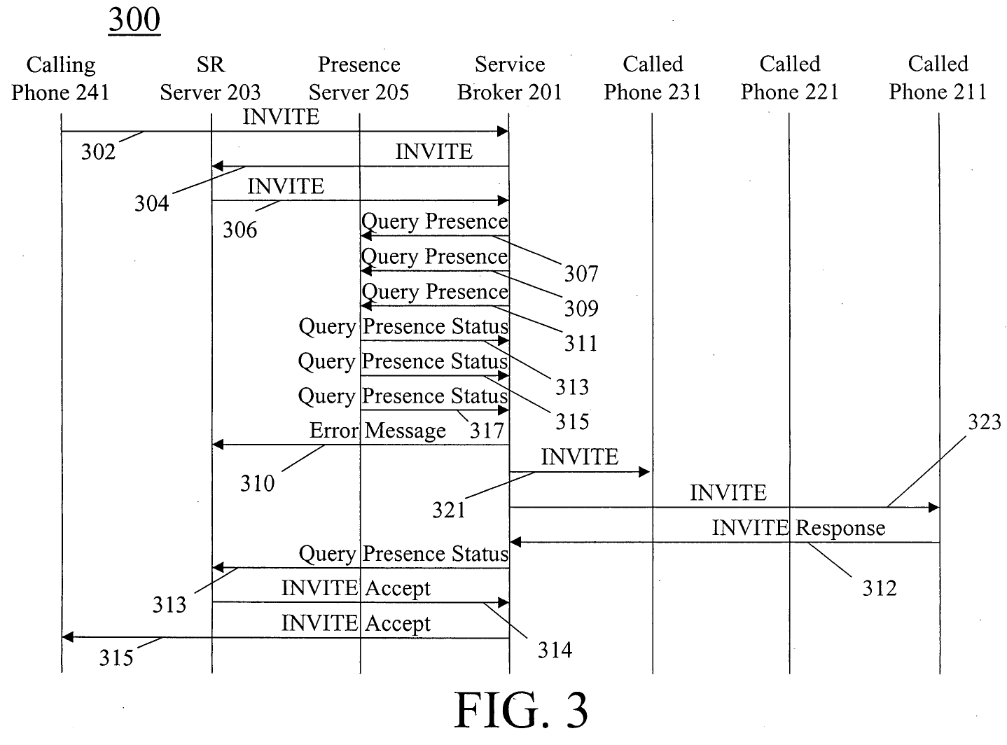

FIG. 2 depicts a logical representation of a Service Broker scenario. Service Broker 201 is disposed between a plurality of phones 211, 221, 231, and 241, and Simultaneous Ring (SR) Server 203 and Presence Server 205. In accordance with this exemplary embodiment, Service Broker 201 intercepts call requests intended for called phones in order to perform Simultaneous Ring and Presence: Check Presence Prior to Terminating service. An exemplary embodiment of this functionality is depicted in FIG. 3.

Service Broker 201 coordinates and controls multiple application servers, first by selectively forwarding incoming SIP request messages to the application servers, and then by intercepting and modifying or re-routing the SIP requests those servers generate and the responses that they get. Thus Service Broker 201 is a cross between a proxy and a router.

As an example, consider the Simultaneous Ringing (SR) service. Service Broker 201 forwards the initial INVITE request to SR server 203, because the called party subscribes to SR service. SR server 203 then sends INVITE requests to the appropriate devices, and waits for their responses. Service Broker 201 intercepts those INVITEs, and for each one, Service Broker 201 gets the target phone's status from the presence server. If the phone is on, Service Broker 201 forwards the INVITE to the device, generally via the S-CSCF, and eventually returns the device's response. However, if a phone is “off”, instead of forwarding the INVITE, Service Broker 201 returns a “device not available” response to SR Server 203, thus terminating that branch.

To accomplish this, a new concept called “steplets” was developed and implemented as the basis of the API. In an exemplary implementation, steplets are Java classes that are used to implement the desired interaction/blending logic. As is the case with servlets (for web servers) and SIP servlets (for SIP application servers), a steplet is an instance of a Java class that extends a class that is part of the API. Steplets are designed to facilitate dynamic sequencing of code (that, for example, would access the services/applications) and have wait-state capability that does not tie up Java thread resources. Steplets also facilitate reuse: steplets forming interfaces to various common applications and application types, as well as steplets providing commonly used logic are made available in a Steplet and Class library. The Steplet and Class library that comes with the API can be augmented with private steplets and classes created for additional desired application server interfaces and other special uses (private library) as well as steplets and classes contributed by a community of interest. Note that the Steplet and Class library, while facilitating reuse where desired and practical, in no way constrains programmers to use existing library implementations.

The Service Broker acts as an extensible SIP router where the desired extensions are provided in steplets programmed in accordance with the API. When the Service Broker receives a SIP request or response message, it calls a steplet or sequence of steplets to determine how to route and/or modify the message. (A default routing is provided that proxies the message on to the next hop, which would be particularly common for treatment of response messages.) Note that the Service Broker may behave in an observe-only mode if desired, in which case its operation is that of a SIP proxy server.

For each service interaction or blended service, a steplet or a sequence of steplets is coded and specified. Upon receipt of a SIP message, a configurable “Default Steplet” may obtain user information from a user data store (this can be local or located in a data store such as the HSS in the IMS solution) that identifies a specific steplet sequence to use. User data may also be used to parameterize the steplets to be invoked. The steplets will execute in sequence, except that any steplet can append and/or delete the steplets that would follow. This makes the sequencing dynamic, and is a key attribute of the Service Broker that enables it to make decisions utilizing external resources for run time information. The dynamic sequencing enables decisions that are conditional based on time-of-day, application server response, Session Context (multi-session, multi-user awareness capabilities), Presence, user parameters such as buddy lists, endpoint status and parameters obtainable from data stores, and other information obtainable by the steplets.

The Service Broker can accommodate users that span multiple endpoints, and can provide customized service presentation based on the users' endpoint capabilities (voice only, voice/data, voice/data/multimedia). Also, the User and Endpoint Data Manager and Session Context—which contain per-user, per-context state information—can be used for multi-session awareness and the managing of both sequential and simultaneous context-dependent activity.

Service Broker 201 acts a proxy if no Steplet(s) are defined and executed on a particular call. Steplets share data objects that are invoked simultaneously on many messages. These data objects are referred to as message objects. Steplets preferably do not store per message data in instance variables within the steplet. Rather, the steplet preferably stores per message data as attributes in the message object. The message object provides methods that allow storage means by which the attributes can be stored and retrieved during the execution of the steplet. The Steplet Message base class includes methods that allow the steplet to implement this concept of storing and retrieving attributes from the message objects.

Each message object has associated with it a steplet list including one or more steplets. The steplet list contains a list of steplets to be run. Steplets in the list are identified by the full class name. A steplet can append a steplet to the list.

Every steplet that is appended to the steplet list associated with a particular message object can add optionally defined parameters for this steplet. Steplet parameters are represented as name-value pairs where the name and value are strings and not arbitrary objects. Once the parameters are set, in an exemplary embodiment, the steplet parameter object is passed to a class in order for the parameters to be associated with that particular steplet. In an exemplary embodiment, a running steplet can access its parameters, but cannot change its parameters once they have been set.

In the exemplary embodiment, the Service Broker assigns a unique string message ID to every message that arrives. The string message ID serves as the message ID.

A Message can be “READY” or “WAITING”. A steplet can change the state of a message from READY to WAITING and vice versa. This is preferably the only way the Message state gets changed. But changing a message to WAITING does not immediately suspend processing of that message. Instead, if a steplet is running on that message, the steplet will continue until the returns. Thus marking a message as “WAITING” really means, “Do not start to execute this message's top Steplet but let the current, if any, running steplet complete.”

In the exemplary implementation, a steplet is considered done when the Steplet Manager removes it from the list or keeps it in a suspended state on the list. The default for the Steplet Manager is to remove the steplet from the list, but can also leave the steplet in a suspended state if instructed to do so by the steplet. This concept is useful when it is desired to suspend the steplet and wait for some condition to happen before continuing with the same steplet. For example, the steplet may be programmed to send a SIP message to an application server and re-invoke that same steplet upon the response from the application server.

In the exemplary implementation, the Service Broker includes a set of convenience methods that return information from the header of the SIP message. The Service Broker can receive multiple messages for a call. In fact, the Service Broker can receive multiple messages of the same type (i.e. INVITE) associated with the Initial Request. This is referred to as the spiral of messages. The basic idea is that as part of the spiral of messages, the Initial Request is the first message that kicked of the entry interaction with the Service Broker. A Secondary Request is a request that has spiraled back as a result of the Initial Request. The Service Broker correlates a secondary request to the initial request.

The Service Broker can forward Request and Response messages on to an Application Server or device. In the exemplary embodiment, the default action of the Service Broker is to forward a copy of the message on to the next hop and make the required SIP changes such as changing the Via header Max Forwards header and other required SIP headers. The Service Broker can be programmed to make additional changes to the SIP message. Once a message is forwarded it is preferably not forwarded again by another steplet.

FIG. 3 depicts a call flow in accordance with an exemplary embodiment of the present invention. In this exemplary embodiment, a Simultaneous Ring and Presence: Check Presence Prior to Terminating service is depicted. In the embodiment depicted in FIG. 3, Simultaneous Ring (SR) set includes Called Phone 211, Called Phone 221, and Called Phone 231, and Called Phone 221 is turned off or otherwise not currently communicating with the communication system. The present invention provides a solution to the problem with a simultaneous ring function when a cell phone is off or an IP phone is unregistered and calls are thereby picked up by voice mail without other devices having time for answer.

Calling phone 241 places a call to the phones in SR set 290, which in this example includes called phone 211, called phone 221, and called phone 231.

Service Broker 201 intercepts the INVITE message 302 from calling phone 241.

Service Broker 201 determines that the called phones in the SR set have SR service. This is done by accessing provisioned user data.

If the called phones have SR service, Service Broker 301 sends INVITE message 304 to SR Server 203.

SR Server 203 determines the devices that are in the SR set. In an exemplary embodiment, SR Server 203 consults a database to determine each of the devices that comprise the SR set.

SR Server 203 sends INVITE messages 306, 326, and 336 to Service Broker 201 for each device that is a member of the SR set. In this embodiment, SR Server 203 sends INVITE message 306 to Called Phone 211, INVITE message 326 to Called Phone 221, and INVITE message 336 to Called Phone 231.

Service Broker 201 receives INVITE messages 306, 326, and 336 and sends a corresponding Query Presence message to Presence Server 205. Query Presence message 307 queries the presence of Called Phone 211, Query Presence message 309 queries the presence of Called Phone 221, and Query Presence message 311 queries the presence of Called Phone 231.

Presence Server 205 determines the status of each device, Called Phone 211, Called Phone 221, and Called Phone 231. This is typically done via a query to a Home Location Register (HLR) or a database containing SIP registration. In this embodiment, Presence Server 205 determines that Called Phone 211 and Called Phone 231 are active, while Called Phone 221 is currently out of service.

For each device, Presence Server 205 returns the status of the device to Service Broker 201. For Called Phone 211 Presence Server 205 sends Query Presence Status message 313, for Called Phone 221 Presence Server 205 sends Query Presence Status message 315, and for Called Phone 231 Presence Server 205 sends Query Presence Status message 317.

For each reply from Presence Server 205, Service Broker 201 performs an appropriate action. For phones that are not in service, an error message is sent to SR Server 203. For called phones in the SR set that are available, an invitation message is sent to the appropriate phone. In the embodiment depicted in FIG. 3, Service Broker 201 sends error message 310 to SR Server 203. Since Called Phone 211 and Called Phone 231 are in service, Service Broker 201 will invite them to answer the call. Service Broker 201 sends INVITE message 321 to Called Phone 211 and sends INVITE message 323 to Called Phone 231.

In the embodiment depicted in FIG. 3, Called Phone 211 is the first phone to answer the call request. Called Phone 211 sends INVITE Response message 312 to Service Broker 201.

Service Broker 201 sends INVITE Response message 313 to SR Server 203. SR Server 203 responds with an INVITE accept message 314 sent to Service Broker 201.

Service Broker 201 sends INVITE Accept message 315 to calling phone 241, thereby completing the call setup and establishing the session.

In an exemplary embodiment, SR Server 203 sends cancel messages to the two called phones that do not answer the call. These cancel messages are preferably routed through Service Broker 201.

Several variations of the described application of the invention are possible, including but not limited to checking presence prior to alerting any phone to bypass its voice mail and checking presence during Find-Me-Follow-Me (FMFM) service. In the latter case, the Service Broker checks presence on calls to be passed on from FMFM to reduce delay in locating the user and reduce use of network resources.

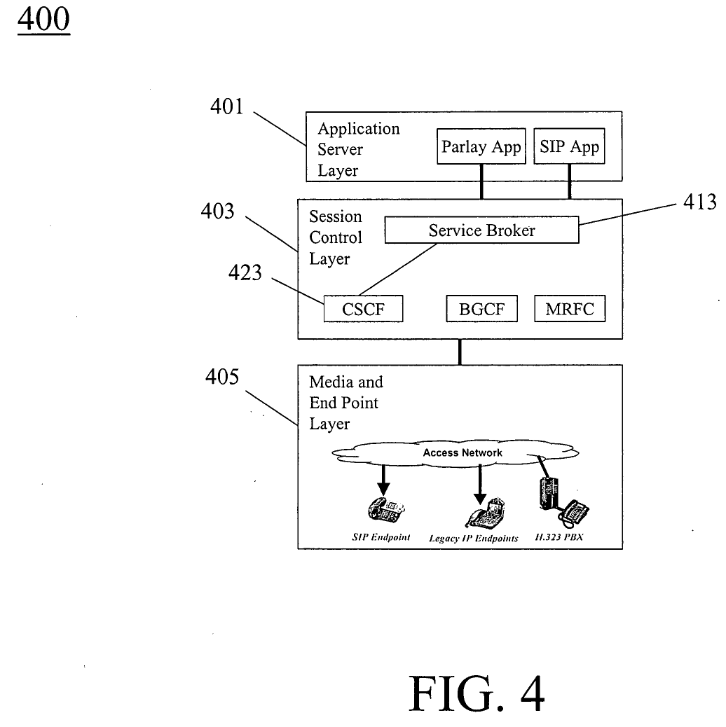

FIG. 4 depicts a communication system 400 in accordance with an exemplary embodiment of the present invention. Communication system 400 is an IMS Architecture that comprises three layers, Application Server Layer 401, Session Control Layer 403, and Transport & Endpoint Layer 405. Similar to communication system 100, if multiple application servers to provide services for end users, then some additional functionality is required to combine and/or broker these services. Service Broker 413 provides this functionality. Service Broker 413 functionality fills a role that is referred to as the Service Capability Interaction Manager (SCIM) in the IMS architecture. This service architecture can simultaneously support many different real-time communication applications.

However, additional service interworking or Service Brokering is needed to blend services and control service interaction. Service Broker 413 resides between the core session layer and Application Server Layer 401, and has corresponding interfaces to the applications. This provides critical functionality such as integrating multiple applications into meaningful service offerings, allowing participating applications to be unaware of each other, and providing programmability with an application programming interface (API) for combining services.

Communication system 400 indicates a logical representation of functions. Service Broker 413 resides between Call Session Control Function (CSCF) proxy server 423 and the application servers. However, there are options in the physical embodiment of this architecture. The actual functionality may reside on an individual physical entity or may be co-located with another function or functions on a single physical entity. Examples would be to co-locate with the CSCF (or SoftSwitch in pre-IMS architectures), with a gateway (such as the Open Systems Architecture (OSA)/Parlay gateway), or with an application on an application server. It is also conceivable that some service brokering could be performed simultaneously in all these locations in a partitioned manner. The session control portion of the IMS architecture is Session Initiation Protocol (SIP) centric, in that the protocol of choice used while communicating between elements in Session Control Layer 403 is SIP. As such, the interface from Service Broker 413 to the CSCF 423 is SIP.

A key aspect of the exemplary embodiment depicted in FIG. 4 is that the IMS architecture is equally suitable for wireless, wireline, and converged networks. Service Broker 413 is fully consistent with this aspect of the IMS architecture as it is inherently endpoint/access neutral. Service Broker 413 also enriches the IMS architecture in that Service Broker 413 manages the integration and coordination of services to control service interaction and/or to provide enriched end-user experiences. Further, Service Broker 413 accommodates users who can span different endpoints, such as analog, softphones, or wireless phones, and can customize service presentation based on the user's endpoint capabilities, such as voice only, voice/data, or voice/data/multimedia. Service Broker 413 can save and use variable user data and session context data to achieve multi-session awareness and manage simultaneous and sequential context-sensitive interactions.

In addition to the “service blending” capability, Service Broker 413 can be used to share network services such as media servers across multiple applications by intercepting their commands and adapting them to a selected media server command interface, although other components in the IMS architecture could provide such sharing. Also, Service Broker 413 may, in conjunction with other systems in the maintenance infrastructure, bring about the consolidation of information for billing and operations support systems and an abstracted view to the other elements in the network.

Service Broker 413 functionality can be implemented in a non-SIP environment, such as a web services environment, providing that the following conditions of service blending can be utilized. A first condition is that multiple applications need to act on the same event/message. A second condition is that pre-defined, but programmable, logic, which has been referred to as corresponding to a “service package”, designates how the event/message and subsequent messages are dispatched. The service package defines a specific composite service, made up of the action and interaction of subtending applications, potentially as well as application capabilities such as Presence, Location, and Policy. The novel Service Broker invention would facilitate the addition of the corresponding code. In this usage, session contexts may be created by the logic as supported by the Service Broker. Session contexts would serve as execution-time entities that keep the context information for related user activity. Session contexts are preferably multiple session aware, see all the associated events and messages, and are used by the Service Packages for feature interaction control.

In this usage, adaptors can be used to accommodate applications with differing interfaces, such as http, Open DataBase Connectivity (ODBC), and other remote procedure call (RPC)-based protocols. Service Broker 413 appears to application servers as a call/connection control network element (S-CSCF, SoftSwitch, proxy server) and it appears to the call/connection control network element as an application server.

The following two examples illustrate the functionality of Service Broker 413. The first example is a very simple use of Service Broker 413 to solve a problem that exists for the “simultaneous ringing” feature. The second is a complex example that illustrates some of the power of Service Broker 413.

The first example relates to Presence-Enabled Simultaneous Ringing. Simultaneous Ringing is a service that allows an incoming call to alert multiple devices, as defined by the user, simultaneously, as described in FIG. 3. The first device to answer gets the termination of the call and results in the cancellation of all other alerting. A current problem with Simultaneous Ringing is that a cell phone that is off will “answer” the call, sending it to the cell phone voice mail, which is typically not desired.

With Presence-Enabled Simultaneous Ringing, Service Broker 413 intercepts the signal for the incoming call, such as the SIP INVITE, and passes it to a Telephony Application Server. The Telephony Application Server supplies the Simultaneous Ringing capability, with a tag that is returned with the multiple signals, such as SIP INVITEs, for the multiple devices to be alerted. Service Broker 413 intercepts these messages and accesses a Network Presence Server that is able to provide cell phone on/off information. Signals, such as SIP INVITEs, destined for a cell phone that is off are either delayed or blocked.

The second example relates to Find Me Follow Me with Calling Party Options. Find Me Follow Me (FMFM) is a service that routes calls based on a set of preferences defined by the user. FMFM may use time of day, day of week, calling party number, and other information to provide a sequential alerting list for a particular call. A current problem with FMFM is that the calling party does not have rich options as to how best complete the call. With FMFM with Calling Party Options, Service Broker 413 can coordinate a plurality of application servers, including Voice Mail, Instant Messaging, Web Server Services, Media Server/IVR, and Presence.

Service Broker 413 intercepts the SIP INVITE for the incoming call and sends it to FMFM. Service Broker 413 intercepts the FMFM SIP INVITE for the first termination try; Service Broker 413 passes this on, and if no answer, will send a reINVITE, sending the call to the Media Server/IVR. This Media Server has been programmed to provide information to Service Broker 413 based in the IVR action. The Calling Party will be given the option of Voice Mail, Instant Message, Web Mail, continue searching. If, for example, Web Mail is chosen, Service Broker 413 accesses the Presence Server to help determine the best device to which to send a web page. The Service Broker sends a message to the Web Server including the calling party number and the end device for the web page.

The Web Server uses the information to locate and parameterize an appropriate web page and sends it to the end device. The Web Server obtains information (if the user provides it) as to which end device to terminate the call. The Web Server passes this information to Service Broker 413, which sends a reINVITE for the original call to be terminated at the specified end device.

While this invention has been described in terms of certain examples thereof, it is not intended that it be limited to the above description, but rather only to the extent set forth in the claims that follow.

We claim:

1. A method for providing a Simultaneous Ring and Check Presence Prior to Terminating service for a plurality of called phones in a simultaneous ring set, the method comprising:
intercepting a call invitation message generated by a calling phone and intended for the simultaneous ring set;
determining that the simultaneous ring set has simultaneous ring service;
determining the status of each of the plurality of called phones that are members of the simultaneous ring set; and
sending an invitation accept message from the service broker to the calling phone, thereby completing the call.

2. A method for providing a Simultaneous Ring and Check Presence Prior to Terminating service for a plurality of called phones in a simultaneous ring set in accordance with claim 1, wherein the step of determining that the plurality of called phones have simultaneous ring service comprises accessing provisioned user data.

3. A method for providing a Simultaneous Ring and Check Presence Prior to Terminating service for a plurality of called phones in a simultaneous ring set in accordance with claim 1, the method further comprising the step of, if the plurality of called phones have simultaneous ring service, sending an invitation message to a simultaneous ring server.

4. A method for providing a Simultaneous Ring and Check Presence Prior to Terminating service for a plurality of called phones in a simultaneous ring set in accordance with claim 1, the method further comprising the step of sending an invitation message from the simultaneous ring server to the plurality of called phones are members of a simultaneous ring set.

5. A method for providing a Simultaneous Ring and Check Presence Prior to Terminating service for a plurality of called phones in a simultaneous ring set in accordance with claim 4, wherein the service broker intercepts the invitation messages intended for the plurality of called phones are members of a simultaneous ring set.

6. A method for providing a Simultaneous Ring and Check Presence Prior to Terminating service for a plurality of called phones in a simultaneous ring set in accordance with claim 4, the method further comprising the step of sending a corresponding Query Presence message to a Presence Server for each of the plurality of called phones are members of a simultaneous ring set.

7. A method for providing a Simultaneous Ring and Check Presence Prior to Terminating service for a plurality of called phones in a simultaneous ring set in accordance with claim 1, the method further comprising the step of determining which of the plurality of called phones are members of the simultaneous ring set.

8. A method for providing a Simultaneous Ring and Check Presence Prior to Terminating service for a plurality of called phones in a simultaneous ring set in accordance with claim 7, wherein the step of determining which of the plurality of called phones are members of the simultaneous ring set comprises consulting a database to determine each of the devices that comprise the simultaneous ring set.

9. A method for providing a Simultaneous Ring and Check Presence Prior to Terminating service for a plurality of called phones in a simultaneous ring set in accordance with claim 1, wherein the step of determining the status of each of the plurality of called phones that are members of the simultaneous ring set comprises querying a Home Location Register (HLR) that includes registration information.

10. A method for providing a Simultaneous Ring and Check Presence Prior to Terminating service for a plurality of called phones in a simultaneous ring set in accordance with claim 1, the method further comprising the step of returning the status of each of the plurality of called phones that are members of the simultaneous ring set from the presence server to the service broker.

11. A method for providing a Simultaneous Ring and Check Presence Prior to Terminating service for a plurality of called phones in a simultaneous ring set in accordance with claim 1, the method further comprising the step of receiving at the service broker an invitation response message from one of the called phones in the SR set that are available.

12. A method for providing a Simultaneous Ring and Check Presence Prior to Terminating service for a plurality of called phones in a simultaneous ring set in accordance with claim 1, the method further comprising the step of sending a cancel message to any called phones that do not answer the call.

13. A method for providing dynamic capabilities in a communication system for service interaction and blending utilizing an application programming interface (API) based on steplets, the method comprising:
receiving a SIP message at a service broker;
sending a message from the Service Broker to a Message Manager upon receipt of the SIP message;
creating a message object for the message;
initializing a steplet list associated with the message object, the steplet list including a default steplet; and
executing the default steplet.

14. A method for providing dynamic capabilities in a communication system in accordance with claim 13, wherein the step of executing the default steplet comprises identifying steplets that are associated with the message.

15. A method for providing dynamic capabilities in a communication system in accordance with claim 13, the method further comprising the step of, upon receiving the SIP message at the service broker, obtaining user information from a user data store.

16. A method for providing dynamic capabilities in a communication system in accordance with claim 13, the method further comprising executing a plurality of steplets in sequence.

17. A method for providing dynamic capabilities in a communication system in accordance with claim 13, the method further comprising executing a plurality of steplets, and wherein each of the plurality of steplets determines which of the plurality of steplets will execute next.
